(19) United States
(12) Patent Application Publication
(10) Pub. No.: US 2004/0120335 A1
(43) Pub. Date: Jun. 24, 2004

(54) Efficient per-queue backpressure signaling

(75) Inventors: Larry Friesen, Nepean (CA); Robert John Johnson, Ottawa (CA); Bin Du, Ottawa (CA); Dion Pike, Dunrobin (CA); Jason Sterne, Ottawa (CA)

Correspondence Address: JONES, TULLAR & COOPER, P.C., P.O. BOX 2266 EADS STATION, ARLINGTON, VA, 22202

(73) Assignee: Alcatel Canada Inc., Kanata (CA)

(21) Appl. No.: 10/326,259

(22) Filed: Dec. 23, 2002

(51) Int. Cl. H04L 12/56

(52) U.S. Cl. 370/412; 370/230

(57) ABSTRACT

High-speed signaling pins are often at a premium in Field Programmable Gate Arrays and minimizing the number of high-speed signals crossing a midplane is desirable to simplify system design and improve reliability. The method disclosed herein provides a more pin-efficient high-speed data path interface with per-queue backpressure signaling than what is available in prior art, leading to reduced system design and manufacturing costs and improved perfonnance. The invention improves upon an industry standard protocol, the SPI 4.2 protocol, for high speed data transmission between switching system components by adding advanced functionality from a widely supported standards proposal, the CSIX level 2. In doing so, the invention offers a hybrid of the two interfaces that is more pin-efficient than either of them.

### BACKGROUND OF THE INVENTION

1. Field of the Invention

This invention relates to an improved method of signaling a backpressure condition on a per-queue basis in a switch and an arrangement for carrying out the method through a pin-efficient high-speed interface between the switch fabric and a network processor or other packet-processing chip.

2. Background Information

A switch fabric can be connected to a network processor through a high-speed fabric interface containing FPGA's (Field Programmable Gate Arrays) and ASIC's (Application Specific Integrated Circuits). This fabric interface must be simple to implement and for reliable operation should use as few interface pins as possible. When a queue in the switch fabric becomes congested, a mechanism is required to signal the backpressure condition, indicating the congested queue to the network processor or packet-processing chip. Although backpressure signaling mechanisms are known in prior art, they are not sufficiently pin-efficient to meet the requirements of a high-speed interface, such as the 7670 RSP (a multiprotocol routing switch platform (RSP) designed to be the basis of next generation networks).

Three types of interface between the switch fabric and the network processor exist in prior art.

Firstly, a proprietary high speed interface, the SQULB (sequential quad utopia-3like bus) interface, is used to provide data path and per-queue backpressure signaling between the switch fabric and network processor. Requiring 132 data and 10 clock and control pins running at a rate to support an OC-192 application, the SQULB data interface has a high number of required pins. The interface between the network processor and the switch fabric is implemented across a high-speed midplane, which is simpler to implement and will operate more reliably with fewer interface pins. The SQULB data path can be serialized to reduce the number of pins across the midplane. Further information on the SQULB protocol can be found in pending U.S. application Ser. No. 09/988,940 filed Nov. 21, 2001 and entitled “High Speed Sequenced Multi-Channel Bus”, which patent application is incorporated herein by reference.

Secondly, the SPI 4.2 is a recently formalized standard for high-speed interfaces, including a lower pin count than the SQULB interface. The standard, which is defined by the “Implementation Agreement OIF-SP14-02.0” by the Optical Internetworking Forum and “POS-PHY Level 4” by Saturn Group, provides for 16 data signals, one clock signal, and one control signal. As well, data rates of at least 832 Mbps are supported, which coincides with the rate required for the OC-192 POS system used in the 7670 RSP. The SPI 4.2 protocol has a backpressure signaling mechanism for the buffer that is receiving data via the SPI 4.2 link. However, this backpressure signaling mechanism cannot also be used for the required per-queue backpressure signaling because the mechanism would equally divide the bandwidth of the backpressure bus between the queues, rather than dynamically determining which queue is backed up. With a large number of queues this becomes inefficient and important backpressure information can be missed. As such, the backpressure signaling mechanism is only applicable to the buffer of the SPI 4.2 link.

Finally, CSIX level 2 is a prior art standards proposal for interfacing a switch fabric to a network processor, such as those made by Intel and Agere. The CSIX level 2 provides a backpressure signaling mechanism that supports per-queue signaling and is operable at the 832 Mbps data rate required by the OC-192 POS feature in the 7670 RSP. Unfortunately, the CSIX level 2 data path requires 20 pins which is not pin-efficient enough to meet the requirements imposed by currently available FPGA's. There are no FPGA3 s available that support enough signals (20) per interface at the data rate needed (832 Mbps). Furthermore, the CSIX level 2 is a new standard and is not yet available in commercial components.

Therefore, a more pin-efficient high-speed data path interface that supports per-queue backpressure signaling is required.

### SUMMARY OF THE INVENTION

The invention provides a means of indicating a congested queue in a switch fabric to a network processor or other packet-processing chip through use of a pin-efficient, high speed data path interface. The invention improves upon an industry standard protocol, the SPI 4.2 protocol, by making use of the CSIX level 2 standard proposal. This is advantageous because high-speed signaling pins are often at a premium in FPGA's.

In its method aspect, the invention is used in a high speed interface between a packet processor and a switch fabric. Data signals are transmitted over a maximum of 18 data paths and a backpressure signaling mechanism returns the backpressure condition signals over a maximum of 9 backpressure paths.

### BRIEF DESCRIPTION OF THE DRAWINGS

FIG. 1 is a block diagram of a data transmission system using the invention.

### DESCRIPTION OF THE PREFERRED EMBODIMENT

The invention relates to an improvement upon an industry standard protocol, the SPI 4.2 protocol, for high speed data transmission between switching system components by adding advanced functionality from a widely supported standards proposal, the CSIX level 2. In doing so, the invention offers a hybrid of the two interfaces that is more pin-efficient than either of them.

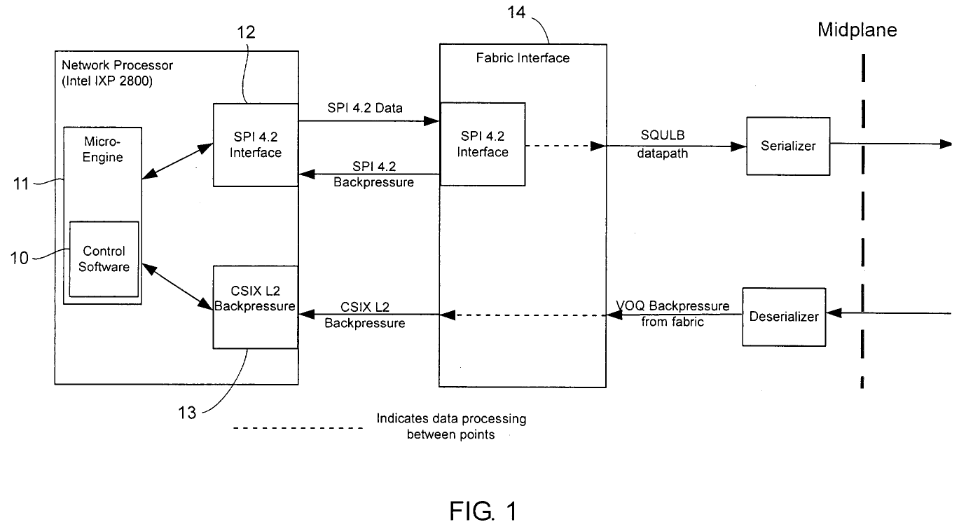

Referring to FIG. 1, a modification is made to the SPI 4.2 interface by using the SPI 4.2 protocol for the data path and the CSIX level 2 standard proposal for the per-queue backpressure signaling. The control software 10 for the network processor's micro-engine 11 provides the interworking required to effect the SPI 4.2 interface 12 with Virtual Output Queuing (VOQ) backpressure signaling received from the CSIX level 2 interface 13.

In one embodiment using the 7670 RSP routing switch platform, the network processor is an Intel IXP2800 and the fabric interface 14 is an FPGA from Altera. This FPGA has two receive (Rx) and two transmit (Tx) interfaces with eighteen signals per interface operating at a maximum rate of 832 Mbps. In this implementation, the data path, under the SPI 4.2 protocol, uses eighteen signals at 832 Mbps from one Rx interface. The backpressure signaling mechanism, under the CSIX level 2 standard proposal, uses 8 signals, 4 data and 4 control, at 832 Mbps from the one Tx interface and another control signal from the other Rx interface.

Thus, an improved method of signaling a back-pressure condition on a per-queue basis over a high-speed connection has been disclosed while remaining within the limitations of the currently available FPGA's. Advantages will lead to reduced system design and manufacturing costs as well as improved performance.

It will be clear to one skilled in the art that the invention is applicable to data queuing and flow control in the broadest sense. In particular, the queues in the fabric could be input queues, output queues or virtual output queues. Further, the backpressure based flow control signals could be associated with arbitrary streams of data that do not have a one-to-one association with a specific queuing structure.

1. A high speed interface between a packet processor and a switch fabric capable of indicating a backpressure condition on a per-queue basis, the packet processor having a data path using a protocol which specifies a limited number of data sfignals, clock signals and control signals, the interface comprising:
a backpressure signaling mechanism using an additional protocol which supports per-queue backpressure signaling using eight additional signals, of which four are information signals and five are control signals, and
a fabric interface with at least two transmit and two receive segments, each capable of providing up to a maximum of the total number of data signals, clock signals and control signals.

2. The interface of claim 1 wherein the total number of data signals, clock signals and control signals is 18.

3. The interface of claim 1 wherein the packet processor is a network processor.

4. The interface of claim 1 wherein the data path follows SPI 4.2 protocol and the backpressure path follows CSIX level 2 protocol.

5. The interface of claim 1 wherein a control code integrates the backpressure signaling mechanism with the data path into a seamless interface.

6. The interface of claim 1 wherein the backpressure condition is indicated on a per-input-queue basis.

7. The interface of claim 1 wherein the backpressure condition is indicated on a per-output-queue basis.

8. The interface of claim 1 wherein the backpressure condition is indicated on a per-data-stream basis.

9. The interface of claim 1 wherein the backpressure condition is indicated on a per-virtual-output-queue basis.

10. The interface of claim 1 wherein the backpressure condition is indicated on a per-quality-of-service-per-output-queue basis.

11. In a high speed interface between a packet processor and a switch fabric operating under a protocol with a limited number of signals, a method of signaling a backpressure comprising the steps of:
transmitting data signals over a first number of data paths, and
returning backpressure condition signals over a second number of backpressure paths,
wherein said first and second numbers are limited to be less than or equal to the total number of data signals, clock signals and control signals.

12. The method of claim 11 wherein said first number is limited to be less than 19 and said second number is limited to be less than 10.

13. The method of claim 11 wherein the packet processor is a network processor.

14. The method of claim 11 wherein the data path follows SPI 4.2 protocol and the backpressure path follows CSIX level 2 protocol.

15. The method of claim 11 wherein a control code integrates the backpressure signaling mechanism with the data path into a seamless interface.

16. The method of claim 11 wherein the backpressure condition is indicated on a per-input-queue basis.

17. The method of claim 11 wherein the backpressure condition is indicated on a per-output-queue basis.

18. The method of claim 11 wherein the backpressure condition is indicated on a per-data-stream basis.

19. The method of claim 11 wherein the backpressure condition is indicated on a per-virtual-output-queue basis.

20. The method of claim 11 wherein the backpressure condition is indicated on a per-quality-of-service-per-output-queue basis.
